(19) United States
(12) Patent Application Publication
(10) Pub. No.: US 2009/0199126 A1
(43) Pub. Date: Aug. 6, 2009

(54) METHOD FOR AUTOMATICALLY ORGANIZING TOOLBARS FOR A SOFTWARE APPLICATION

(75) Inventors: Bhavan Kasivajjula Kumar, Maharashtra (IN); Kannepalli Venkata Sreekanth, Pune (IN)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/026,800

(22) Filed: Feb. 6, 2008

(51) Int. Cl. G06F 3/048

(52) U.S. Cl. 715/779

(57) ABSTRACT

A method of automatically organizing toolbars on a user interface for a software application includes calculating an amount of free space in the first toolbar row of the user interface, determining a size of a toolbar in a second toolbar row of the user interface, and automatically moving the tool bar from the second tool bar row to the free space in the first tool bar row if the amount of free space in the first toolbar row is greater than the size of the toolbar. Moving the toolbar to the first toolbar row maximizes available free space for an application window of the computer application.

### BACKGROUND OF THE INVENTION

1. Field of the Invention

This invention relates to the art of computer applications and, more particularly to a system for automatically managing toolbars for a software application.

2. Description of Background

Conventionally, toolbars are located at upper and lower regions of a computer application. The toolbars include various buttons that, when activated, establish a short cut to various computer application content such as, formatting, editing, drawing and other functions. Typically, multiple toolbars occupy portions or fragments of toolbar rows. As the number of toolbars employed by a user increases, so do toolbar rows. Ultimately, toolbar rows begin to encroach upon an application window portion of the computer application.

Various solutions exist that allow a user to organize toolbars. Users can add and delete buttons from toolbars in order to make efficient use of available space. That is, buttons that are used often are left in the toolbar and buttons that are used less often are deleted from the toolbar. In addition, systems exist that allow a user to manually resize toolbars, or manually move toolbars to different locations in the application. Other systems have an auto- arrange feature that removes “white space” between adjacent toolbars on a toolbar row and left aligns the toolbar on the toolbar row. Despite the existing solutions to toolbar organization, toolbars remain fragmented across multiple toolbars rows, robbing precious space from the application window.

### SUMMARY OF THE INVENTION

The shortcomings of the prior art are overcome and additional advantages are provided through the provision of a method of automatically organizing toolbars on a user interface for a software application. The method includes calculating an amount of free space in the first toolbar row of the user interface, determining a size of a toolbar in a second toolbar row of the user interface, and automatically moving the tool bar from the second tool bar row to the free space in the first tool bar row if the amount of free space in the first toolbar row is greater than the size of the toolbar. Moving the toolbar to the first toolbar row maximizes available free space for an application window of the computer application.

System and computer program products corresponding to the above-summarized methods are also described and claimed herein.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution, which maximizes available space for an application window of a computer application by automatically organizing toolbar distribution within and among one or more toolbar rows in order to minimize an overall footprint of a user interface portion of the computer application.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a computer application including a method of organizing toolbars in accordance with an exemplary embodiment of the present invention;

FIG. 2 illustrates a flow diagram depicting a method of organizing toolbars for a software application in accordance with an exemplary embodiment of the present invention; and

FIG. 3 is the computer program application after organizing the toolbars in accordance with an exemplary embodiment of the present invention.

The detailed description explains the exemplary embodiments of the invention, together with advantages and features, by way of example with reference to the drawings.

### DETAILED DESCRIPTION OF THE INVENTION

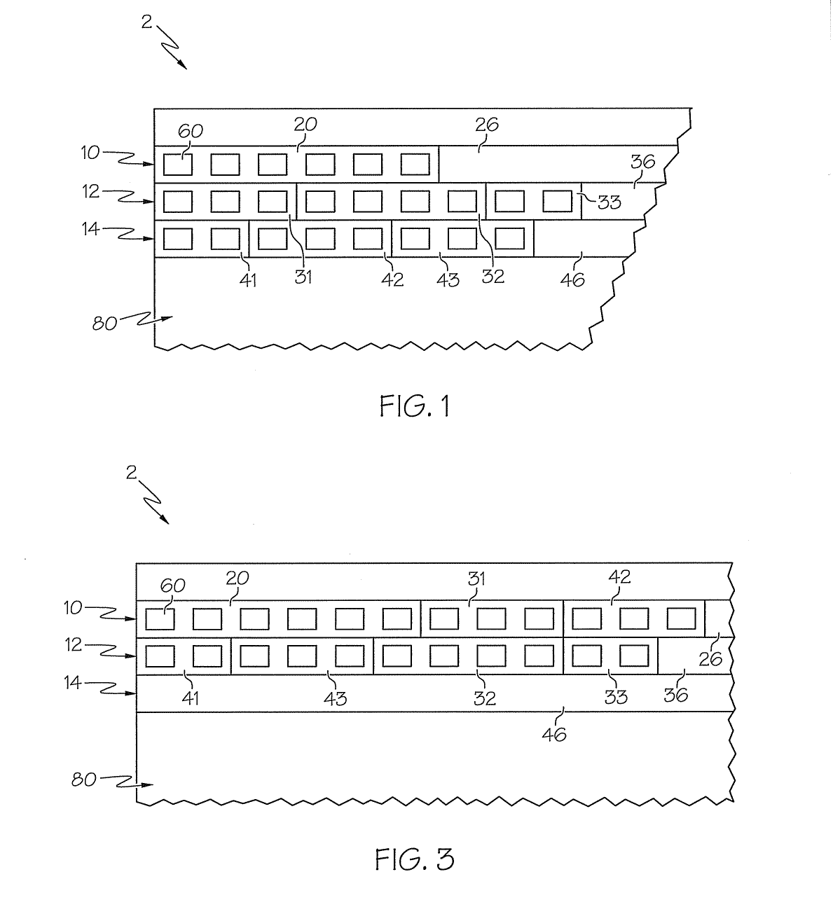

With initial reference to FIG. 1, a computer application 2 includes a plurality of toolbar rows 10, 12 and 14 as seen by a user on a computer display device (not shown). In a manner known in the art, toolbar row 10 includes one or more associated toolbars indicated at 20 as well as free space 26, toolbar row 12 includes one or more associated toolbars indicated at 31-33 and free space 36 and toolbar row 14 includes one or more associated toolbars indicated at 41-43 and free space 46. At this point it should be understood that by “free space” it is meant space in a toolbar row that is not occupied by a toolbar or the like. In any event, each toolbar includes a plurality of icons, one of which is indicated at 60 that are used to activate various features of computer application 2. In the exemplary embodiment shown, icon 60 activates a routine or method that automatically organizes toolbars 20, 31-33 and 41-43 into the fewest number of toolbar rows so as to maximize free space for an application window 80.

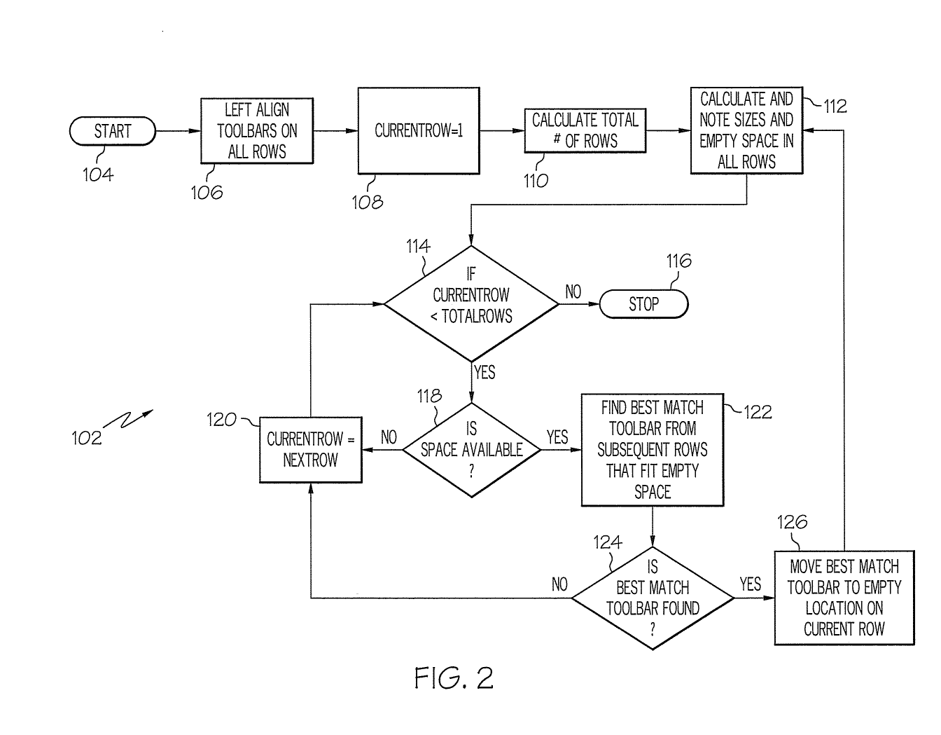

Reference will now be made to FIG. 2 in describing a method 102 of automatically organizing toolbars in a computer program or application. Initially upon a user selecting to automatically organize existing toolbars in block 104, all active toolbars on, for example, a computer application desktop, are left aligned as indicated in block 106. At this point, a current toolbar row is established as indicated in block 108. Initially, the first or uppermost toolbar row is designated as the current toolbar row. However, as method 102 progresses, each toolbar row is, at some point, designated as the current toolbar row. After establishing the current toolbar row, method 102 determines a total number of tool bar rows in block 110 and calculates free or available space in each toolbar row as indicated in block 112. The total number of rows establishing the last toolbar row for the computer application. If the current row is the same as the total number of rows as determined in block 114, organizing halts. That is, if there exists only a single toolbar row or, as will be discussed more fully below, the row designated as the current row is the last toolbar row, method 102 ends at block 116 and organization is complete.

If, in block 114, it is determined that the current row is not the only or last row, method 102 then determines whether there is free space available in the current row as indicated in block 118. If no free space is available in the current row, the next or subsequent row is designated as the current row in block 120 and method 102 returns to block 114. If free space is available in the current row as determined in block 118, method 102 scans toolbars present in each subsequent row as shown in block 122. More specifically, a size of each toolbar in all subsequent rows is calculated to determine a best match toolbar for the current row. That is, the size of each toolbar in all subsequent rows is compared to the free space available in the current row. The best match toolbar would be the toolbar(s) that would occupy all or substantially all of the free space in the current row. If a best match toolbar(s) is found, as determined in block 124, the best match toolbar(s) is moved to the current row as indicated in block 126.

Once all, or substantially all, of the free space in the current row is occupied, the next row is designated as the current row as indicated in block 120. Likewise, if no best match toolbar is located for the current row in block 124, the next row is designated as the current row in block 20 and the method returns to block 114. This process continues until all rows are completely or as near to being completely occupied as possible, and the fewest number of toolbar rows are present in the application. In this manner, space for an application window portion of the computer application is maximized.

For example, in computer application 2, after selecting to automatically organize toolbar through, for example, icon 60, method 102 left aligns toolbars 20, 31-33 and 41-43 as shown in FIG. 1. At this point, toolbar row 10 is designated as the first row and the size of free space 26, 36 and 46 is determined. Given that toolbar row 10 is not the only toolbar row, or the last toolbar row, and free space 26 is present, method 102 looks for the best match tool bar by scanning or evaluating toolbars 31-33 and 41-43. At this point, method 102 determines that toolbars 31 and 42 are the best match toolbars for free space 26. Thus, toolbars 31 and 42 are moved to row 10 and positioned adjacent toolbar 20 as shown in FIG. 3. Next, method 102 designates toolbar row 12 as the current toolbar row. Toolbar row 12 now has free space 36 plus additional free space previously occupied by toolbar 31. Method scans toolbar row 14 for best match toolbars and determines that toolbars 41 and 43 are a best match to occupy free space 36 and the additional free space previously occupied by tool bar 31. Toolbars 41 and 43 are then moved into toolbar row 12. In this manner, the present invention automatically organizes/optimizes toolbar allocation in order to maximize usable area for application window 80.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of automatically organizing toolbars on arranged in a plurality of toolbar rows of a user interface for a software application comprising:
calculating an amount of free space in a first toolbar row of the user interface;
determining a size of a toolbar in a second toolbar row of the user interface; and
automatically moving the toolbar from the second tool bar row to the free space in the first tool bar row if the amount of free space in the first toolbar row is greater than the size of the toolbar, wherein moving the toolbar to the first toolbar row maximizes available free space for an application window of the computer application.

2. The method of claim 1, further comprising:
determining a size of another toolbar in a third toolbar row of the user interface portion of the computer application;
calculating an amount of free space in the first toolbar row;
calculating an amount of free space in the second toolbar row;
automatically moving the another toolbar from the third toolbar row to the free space in the first toolbar row of the amount of free space in the first toolbar row is greater than the size of the another toolbar; and
automatically moving the third toolbar from the third toolbar row to the free space in the second tool bar row if the free space in the first toolbar row is smaller than the size of the another toolbar and the free space in the second toolbar row is greater than the size of the another toolbar.

3. The method of claim 1, further comprising:
determining size of each toolbar in remaining ones of the plurality of toolbar rows
determining a best match toolbar from one of the remaining ones of the plurality of toolbars, the best match tool bar being sized to substantially match the amount of free space in the first toolbar row; and
automatically moving the best match toolbar from the one of the remaining ones of the plurality of toolbar rows to the free space in the first toolbar row.
